(19) United States
(12) Patent Application Publication
(10) Pub. No.: US 2024/0177383 A1
(43) Pub. Date: May 30, 2024

(54) METHOD FOR PROCESSING IMAGE AND ELECTRONIC DEVICE

(71) Applicant: BEIJING DAJIA INTERNET INFORMATION TECHNOLOGY CO., LTD., Beijing (CN)

(72) Inventors: Peng LU, Beijing (CN); Yuehua REN, Beijing (CN)

(21) Appl. No.: 18/489,254

(22) Filed: Oct. 18, 2023

(30) Foreign Application Priority Data
Nov. 29, 2022 (CN) 202211511476.2

(51) Int. Cl. G06T 11/60; H04N 21/2187

(52) U.S. Cl. CPC G06T 11/60; H04N 21/2187

(57) ABSTRACT

Provided is a method for processing an image, which relates to the field of image processing technologies. The method includes: acquiring a template background image and a title style corresponding to a reward identifier, and acquiring a title text corresponding to a target type identifier; acquiring a target image corresponding to the reward identifier and the target type identifier by synthesizing the title text into the template background image based on the title style, the target image representing reward information corresponding to the target type identifier; and accordingly saving the reward identifier, the target type identifier, and the target image.

The present disclosure is based on and claims priority to Chinese Patent Application No. 202211511476.2, filed on Nov. 29, 2022, the disclosure of which is herein incorporated by reference in its entirety.

### TECHNICAL FIELD

The present disclosure relates to the field of image processing technologies, and in particular, relates to a method for processing an image and an electronic device.

### BACKGROUND

In large live-streaming events such as festival live-streaming events, an exclusive avatar frame will be awarded to the winning anchor account, giving the anchor account exclusive honor.

In a competitive live-streaming event, different types of winning anchor accounts can be distinguished by their avatar frame types. Taking a certain festival live-streaming event as an example, over 300 types of avatar frames for winners may be needed according to participating cities and types, which means that more than 300 avatar frames need to be designed. To generate avatar frames for a live-streaming event, first, designers need to design target images for each city and each type. Then, product personnel manually configure the target images of each type to the background to generate corresponding reward identifiers, and then manually configure the reward identifiers to the database.

### SUMMARY

The present disclosure provides a method for processing an image and an electronic device, so as to at least solve the problems of error proneness and low processing efficiency of image processing in the related art. The technical solutions of the present disclosure are as follows:

According to an aspect of embodiments of the present disclosure, a method for processing an image is provided. The method includes: acquiring a template background image and a title style corresponding to a reward identifier, and acquiring a title text corresponding to a target type identifier; acquiring a target image corresponding to the reward identifier and the target type identifier by synthesizing the title text into the template background image based on the title style, the target image representing reward information corresponding to the target type identifier; and accordingly saving the reward identifier, the target type identifier, and the target image.

According to another aspect of embodiments of the present disclosure, an electronic device is provided. The electronic device includes: a processor; and a memory configured to store one or more instructions executed by the processor; wherein the processor, when loading and executing the one or more instructions, is caused to perform: acquiring a template background image and a title style corresponding to a reward identifier, and acquiring a title text corresponding to a target type identifier; acquiring a target image corresponding to the reward identifier and the target type identifier by synthesizing the title text into the template background image based on the title style, the target image representing reward information corresponding to the target type identifier; and accordingly saving the reward identifier, the target type identifier and the target image.

According to another aspect of embodiments of the present disclosure, a non-transitory computer-readable storage medium is provided. The non-transitory computer-readable storage medium stores one or more instructions therein, wherein the one or more instructions, when loaded and executed by a processor of an electronic device, cause the electronic device to perform: acquiring a template background image and a title style corresponding to a reward identifier, and acquiring a title text corresponding to a target type identifier; acquiring a target image corresponding to the reward identifier and the target type identifier by synthesizing the title text into the template background image based on the title style, the target image representing reward information corresponding to the target type identifier; and accordingly saving the reward identifier, the target type identifier and the target image.

According to another aspect of embodiments of the present disclosure, a computer program product including one or more computer programs or one or more computer instructions is provided. The one or more computer programs or one or more computer instructions, when executed by a processor, cause the electronic device to perform: acquiring a template background image and a title style corresponding to a reward identifier, and acquiring a title text corresponding to a target type identifier; acquiring a target image corresponding to the reward identifier and the target type identifier by synthesizing the title text into the template background image based on the title style, the target image representing reward information corresponding to the target type identifier; and accordingly saving the reward identifier, the target type identifier, and the target image.

### BRIEF DESCRIPTION OF THE DRAWINGS

FIG. 1 is a flowchart illustrating a method for processing an image according to some embodiments of the present disclosure;

FIG. 2(a) and FIG. 2(b) are exemplary diagrams of avatar frame reward images for different tracks according to some embodiments of the present disclosure;

FIG. 3 is an interaction diagram illustrating a method for processing an image according to some embodiments of the present disclosure;

FIG. 4 is a block diagram of an apparatus for processing an image according to some embodiments of the present disclosure; and

FIG. 5 is a block diagram of an electronic device according to some embodiments of the present disclosure.

### DETAILED DESCRIPTION

The user information to which the present disclosure relates is information that is authorized by the user or sufficiently authorized by parties.

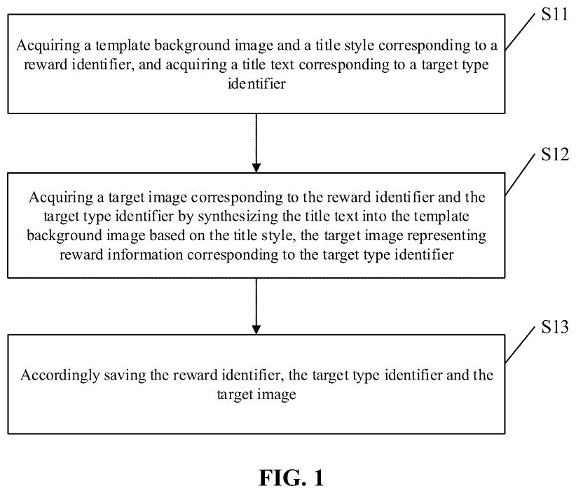

FIG. 1 is a flowchart illustrating a method for processing an image according to some embodiments of the present disclosure. As shown in FIG. 1, the method for processing the image may be executed by electronic devices, such as a server. The server may be one or more servers that provide a live-streaming event. The method may be used for processing an image in a competitive live-streaming event. The method includes the following processes.

In S11, a template background image and a title style corresponding to a reward identifier are acquired, and a title text corresponding to a target type identifier is acquired.

The template background image is, for example, an avatar frame image, a medal image, a skin card image, or the like. The title style is a presentation style of the title text in a target image, and includes information, such as a font, a font size, a color, and a word space. One competitive live-streaming event corresponds to one reward identifier. In some embodiments, the reward identifier corresponds to a plurality of type identifiers. The target type identifier is configured to represent a corresponding target type, and the target type is, for example, a target track, a target category, or the like. The target tracks are divided, for example, based on different regions, and the target categories are divided, for example, based on product categories for a live-streaming event. The title text describes a rank corresponding to the target type identifier in the competitive live-streaming event.

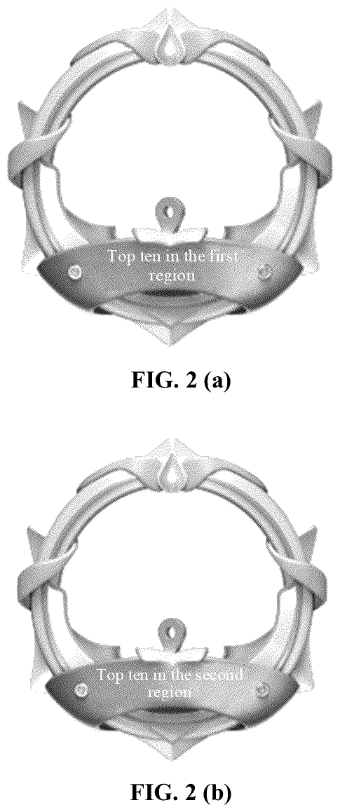

Taking the target type as the target track as an example, as can be seen from FIG. 2(a) and FIG. 2(b), the following description will illustrate the avatar frame reward images for different tracks. FIG. 2(a) and FIG. 2(b) are exemplary diagrams of avatar frame reward images for different tracks according to some embodiments of the present disclosure. If the avatar frame reward images for different tracks are configured separately with different designs, the amount of work for design and configuration is large because there can be many tracks in a competitive live-streaming event. According to the embodiments of the present disclosure, the efficiency of generating the avatar frame award can be improved, and the amount of work can be reduced. As shown in FIGS. 2(a) and 2(b), the avatar frame reward images for different tracks (e.g., avatar frame reward images for the top ten in the first region as shown in FIG. 2(a) and avatar frame reward images for the top ten in the second region as shown in FIG. 2(b)) are only different in the content of the presented title text. In this case, for different tracks, only the template background image and the title style of the avatar frame reward images are designed, and the title text can be then synthesized into the template background image based on the title style, such that the target image can be obtained. In the example in FIG. 2(a) and FIG. 2(b), the target type is the target track, and the target track is divided into a first region and a second region. The title text corresponding to the target type (i.e., the target track) identifier, is “top ten in the first region” and “top ten in the second region.”

In some embodiments, a template background image and a title style corresponding to one competitive live-streaming event may be designed, one competitive live-streaming event corresponds to one reward identifier, and the template background image and the title style corresponding to the reward identifier are saved. For example, the reward identifier, the template background image and the title style corresponding to the reward identifier are stored into the local database of the electronic device, such that the electronic device can use the reward identifier as an index to query in the local database, to obtain the corresponding template background image ant the tile style. In the case that a target image needs to be generated, a designed template background image and a designed title style are acquired based on a reward identifier, and a title text corresponding to a target type identifier in the competitive live-streaming event is acquired. The title text corresponding to the target type identifier is set corresponding to the target type when the competitive live-streaming event is set. That is, in the case of setting the competitive live-streaming event, the title texts corresponding to all the type identifiers in the competitive live-streaming event are set. The competitive live-streaming event is, for example, a large festival live-streaming event.

In S12, a target image corresponding to the reward identifier and the target type identifier is acquired by synthesizing the title text into the template background image based on the title style, the target image representing reward information corresponding to the target type identifier.

In some embodiments, the title text is synthesized into the template background image through image synthesis to obtain the target image. In some embodiments, the title text and the template background image are synthesized through webpage editing, and the target image is obtained by slicing.

Exemplarily, in the case that the title text is synthesized into the template background image through image synthesis, the title text is edited based on the title style, the title text is edited into a text of the title style, the text of the title style is synthesized into the template background image, and the title text can be synthesized into the position in the template background image based on the position of the title text for the title style in the template background image, so as to obtain a target image corresponding to the reward identifier and the target type identifier. The target image is reward information corresponding to the target type identifier and is an exclusive honor given to the winning account. The target image is an image file in a preset format, such as PNG format, or other formats, which are not limited herein.

In some embodiments, acquiring the target image corresponding to the reward identifier and the target type identifier by synthesizing the title text into the template background image based on the title style includes: generating, based on the title style and the template background image, a webpage template component; acquiring a webpage picture by synthesizing the title text into the webpage template component; and acquiring the target image by converting the webpage picture into an image.

The webpage picture is a picture in a webpage.

Exemplarily, in some embodiments, the title text is synthesized into the template background image by using VUE technology (short for Vue.js, an open source JavaScript frame configured to create a user interface) and html2canvas technology (an open source plug-in for taking screenshots from browser webpages). For example, VUE codes for generating the webpage template component are written, the VUE codes are read by using a VUE dynamic component technology to generate a dynamic template component, a configuration list including a title style and a template background image is acquired, the configuration list is read, the title style and the template background image in the configuration list are substituted into the dynamic template component to generate the webpage template component, the position of the title text in the webpage template component is a default text of the title style, the title text in the configuration list is synthesized to the position of the title text in the webpage template component to obtain a webpage picture, and the generated webpage picture can be previewed. In some embodiments, the webpage picture is converted into an image for display by using the html2canvas technology, and screenshots are taken by using the canvas to obtain a target image corresponding to the reward identifier and the target type identifier. The configuration list can configure the title texts corresponding to a plurality of target type identifiers, and further generate the target images corresponding to the plurality of target type identifiers in batch.

The title text is synthesized into the template background image through webpage synthesis to obtain the target image, the target images corresponding to a plurality of target type identifiers can be processed in batch, and thus the generation efficiency of the target images is further increased.

In S13, the reward identifier, the target type identifier, and the target image are saved accordingly.

In some embodiments, the target images corresponding to the reward identifiers and the target type identifiers are saved or stored in a database or a content delivery network, such that the target images can be sent to list entry accounts in a reward list after the reward list corresponding to the target type identifiers is determined. The list entry accounts are the accounts that enter the reward list of the competitive live-streaming event.

In the method for processing the image according to the embodiments, the template background image and the title style corresponding to the reward identifier are acquired, and the title text corresponding to the target type identifier is acquired; the target image that represents the reward information corresponding to the reward identifier and the target type identifier is acquired by synthesizing the title text into the template background image based on the title style; and the reward identifier, the target type identifier, and the target image are accordingly stored. As only the template background image and the title style need to be manually configured, the target image corresponding to each target type identifier can be synthesized based on the template background image and the title style and automatically saved, such that it is not necessary to manually configure each type of target image, thereby avoiding human errors and increasing the processing efficiency.

On the basis of the above technical solutions, before acquiring the template background image and the title style corresponding to the reward identifier, the method further includes:
acquiring a template background image and a title style corresponding to a target activity identifier, the target activity identifier corresponding to at least one type identifier; and
generating a reward identifier corresponding to the template background image and the title style, and establishing a corresponding relation between the reward identifier and the at least one type identifier.

The target activity identifier is configured to characterize the target activity, such as a competitive live-streaming event, a non-competitive live-streaming event. The target type identifier is configured to characterize the target type corresponding to the target activity, such as a target track, a target category. Taking FIG. 2 as an example, FIG. 2(a) and FIG. 2(b) show the target images obtained based on different tracks (i.e., characterized by target activity identifiers) under the same competitive live-streaming event (i.e., characterized by target type identifiers). For the target activity identifier, a template background image and a title style designed by the designer are acquired, wherein the template background image refers to a background image without the title text, for example, a background image of an avatar frame without the title text. In the case that the template background image and the title style delivered by the designer are acquired, the reward identifier corresponding to the template background image and the title style is generated, the reward identifier is configured in the database where at least one type corresponding to the target activity identifier, and the corresponding relation between the reward identifier and the at least one type identifier is established, such that the template background image and the title style corresponding to the target type identifier can be subsequently acquired based on the corresponding relation, so as to generate the target image.

On the basis of the above technical solutions, acquiring the template background image and the title style corresponding to the reward identifier, and acquiring the title text corresponding to the target type identifier includes: acquiring, in the case that the ending time corresponding to the target type identifier is reached, the template background image and the title style corresponding to the reward identifier, and acquiring the title text corresponding to the target type identifier. In some examples, a target type corresponds to a target activity such as a target track in the live-streaming event. The ending time corresponding to the target type identifier is the time when the target track is ended.

In the case that the ending time corresponding to the target type identifier is reached, namely in the case that the reward list corresponding to the target type identifiers is determined, a template background image and a title style corresponding to the reward identifier are acquired from a database based on the reward identifier, and a title text corresponding to the target type identifier is acquired, and the operation of synthesizing the title text into the template background image is completed at this time. In this way, the template background image and/or the title style can be modified before the rank list is determined, and the target image does not need to be re-synthesized, thereby reducing the operation of re-synthesizing the target image caused by modifying the template background image and/or the title style.

On the basis of the above technical solutions, in some embodiments, saving the reward identifier, the target type identifier, and the target image includes: sending the target image to a content delivery network, and acquiring a download address of the target image from the content delivery network, the content delivery network being configured to save the target image and provide a downloading service of the target image; and accordingly saving the reward identifier, the target type identifier, and the download address.

After the target image is generated, the target image is sent to the content delivery network, the content delivery network saves the target image and provides a downloading service of the target image, the content delivery network sends back the download address of the target image after saving the target image, and then the download address of the target image is acquired from the content delivery network, and the download address corresponding to the reward identifier and the target type identifier is saved in a database. The database may be configured in the server that provides the live-streaming service. In this way, the target image can be subsequently issued to a list entry account after the reward list is determined, and the issuing speed of the target image is increased by issuing through the content delivery network.

On the basis of the above technical solutions, the method for processing the image further includes: acquiring, in the case that the ending time corresponding to the target type identifier is reached, a list entry account identifier corresponding to the target type identifier, the list entry account identifier being an account identifier in a reward list corresponding to the target type identifier; and establishing a corresponding relation between the list entry account identifier and the reward identifier. The list entry account is an account that enters the reward list after accounts participating in the live-streaming event are ranked.

In the case that the ending time corresponding to the target type identifier is reached, namely in the case that the reward list corresponding to the target type identifiers is determined, the list entry account identifiers in the reward list corresponding to the target type identifiers are acquired, and the corresponding relation between the list entry account identifiers and the reward identifiers is established. Namely, the list entry account identifiers and the reward identifiers are bound. In some examples, one reward identifier corresponds to one competitive live-streaming event. A reward list corresponds to the competitive live-streaming event, and includes a plurality of list entry accounts that wins the competition, each participant account has a list entry account identifier and corresponds to a reward identifier. In this way, the target image corresponding to the reward identifier can be subsequently issued based on a request of the list entry account identifier.

On the basis of the above technical solutions, the method for processing the image further includes: receiving an acquisition request of a client for a target image, the acquisition request including a target account identifier; determining, based on the corresponding relation between the list entry account identifier and the reward identifier, a reward identifier corresponding to the target account identifier, and acquiring a download address corresponding to the reward identifier; and sending the download address to the client, the download address directing the client to download the target image based on the download address.

In the case that the reward list corresponding to the target type identifiers is determined, user accounts under the target type can request the target image corresponding to the target type identifier through the client. The electronic device receives the acquisition request of the client for the target image; analyzes the acquisition request to obtain a target account identifier from the acquisition request; determines a target type identifier corresponding to the client; acquires a list entry account identifier corresponding to the target type identifier based on the determined target type identifier; determines whether the target account identifier is included in the list entry account identifier; in the case that the list entry account identifiers include the target account identifier, determines a reward identifier corresponding to the target account identifier from the corresponding relation between the list entry account identifiers and the reward identifiers; acquires a download address corresponding to the reward identifier from a database; and sends the download address to the client. Thus, the client can download the target image corresponding to the reward identifier from a corresponding content delivery network based on the download address. In this way, the target image representing the target type honor is issued to the client, and the target image is issued through the content delivery network based on the download address, such that the issuing speed of the target image is increased.

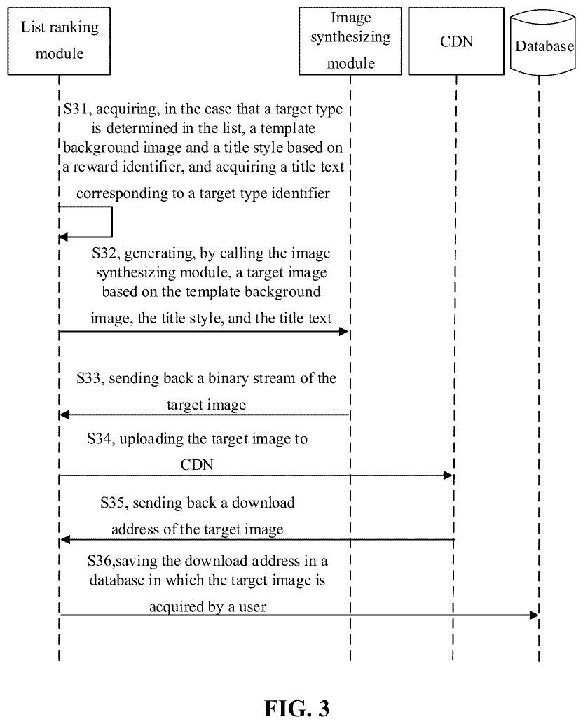

In some embodiments of the present disclosure, the method for processing the image can be executed cooperatively by a list ranking module and an image synthesizing module. FIG. 3 is an interaction diagram illustrating a method for processing an image according to some embodiments of the present disclosure. As shown in FIG. 3, the method for processing the image includes the following processes.

In S31, in the case that a target type is determined in the reward list, the list ranking module acquires a template background image and a title style based on a reward identifier, and acquires a title text corresponding to a target type identifier.

In S32, the image synthesizing module is called to generate a target image based on the template background image, the title style, and the title text.

In S33, the image synthesizing module sends back a binary stream of the target image, wherein the stream is a concept abstracted for the input and output of data, and the binary stream is one in which the data flowing in the stream is a sequence of binary digits.

In S34, the list ranking module uploads the target image to a content delivery network (CDN).

In S35, the CDN sends back a download address of the target image.

In S36, the list ranking module saves the download address in a database in which a user can acquire the target image.

The target image is subsequently issued based on the download address and the request of a client.

In the processes, the image synthesizing module synthesizes the target image by using a front-end technology, that is, by using VUE technology and html2canvas technology, and for a specific synthesis process, reference is made to the above embodiments, which will not be described in detail herein.

In some embodiments, the list ranking module and the image synthesizing module are configured in different servers, and in some embodiments, the list ranking module and the image synthesizing module are configured in the same server.

According to some embodiments, the target image of the target type is synthesized based on the template background image, the title style, and the title text, and the target image does not need to be configured for each type individually and manually, such that human errors are avoided, the processing efficiency is increased, and the working efficiency of posts of research and development, products, design, and the like is increased.

According to some embodiments of the present disclosure, a method for processing an image in a competitive live-streaming event is provided. The method may be executed by an electronic device. In some embodiments, the electronic device may be a server or a live-streaming server for implementing the competitive live-streaming event. In some embodiments, the electronic device may be more than one servers configured to implement the method. The method includes: acquiring, in a case that an ending time corresponding to a target type identifier is reached, a template background image and a title style corresponding to a reward identifier, and acquiring a title text corresponding to the target type identifier, wherein the reward identifier corresponds to the competitive live-streaming event, and the target type identifier is configured to represent a corresponding target type, the title style is a style of the title text, and the title text describes a rank corresponding to the target type identifier in the competitive live-streaming event; acquiring a target image corresponding to the reward identifier and the target type identifier by synthesizing the title text into the template background image based on the title style, wherein the target image representing reward information corresponding to the target type identifier in the competitive live-streaming event, wherein the target image is synthesized by using a front-end technology; sending the target image to a content delivery network, and acquiring a download address of the target image from the content delivery network, wherein the content delivery network is configured to store the target image and provide a downloading service of the target image; and sending the download address to a client in response to an acquisition request from the client for the target image to enable the client to obtain the target image.

In some embodiments, the front-end technology is a VUE technology or a html2canvas technology as described above.

In some embodiments, sending the download address to the client in response to the acquisition request from the client for the target image comprises: analyzing the acquisition request to obtain a target account identifier from the acquisition request; determining a target type identifier corresponding to the client; acquiring a list entry account identifier corresponding to the target type identifier based on the determined target type identifier; determining whether the target account identifier is included in the list entry account identifier; in the case that the list entry account identifiers include the target account identifier, determining a reward identifier corresponding to the target account identifier from the corresponding relation between the list entry account identifiers and the reward identifiers; and acquiring a download address corresponding to the reward identifier from the content delivery network.

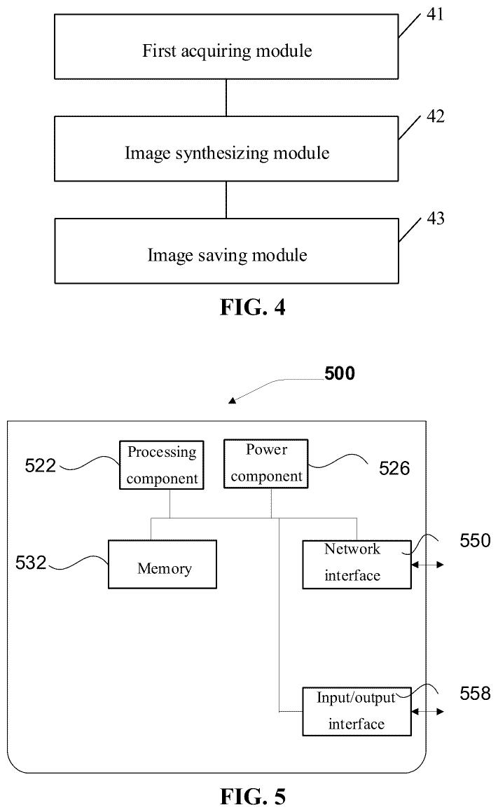

FIG. 4 is a block diagram of an apparatus for processing an image according to some embodiments of the present disclosure. Referring to FIG. 4, the apparatus includes a first acquiring module 41, an image synthesizing module 42, and an image saving module 43.

The first acquiring module 41 is configured to acquire a template background image and a title style corresponding to a reward identifier, and acquire a title text corresponding to a target type identifier.

The image synthesizing module 42 is configured to acquire a target image corresponding to the reward identifier and the target type identifier by synthesizing the title text into the template background image based on the title style, the target image representing reward information corresponding to the target type identifier.

The image saving module 43 is configured to accordingly save the reward identifier, the target type identifier, and the target image.

In some embodiments, the image synthesizing module 42 includes:
a template component generating unit, configured to generate, based on the title style and the template background image, a webpage template component;
a webpage picture synthesizing unit, configured to acquire a webpage picture by synthesizing the title text into the webpage template component; and
a target image generating unit, configured to acquire the target image by converting the webpage picture into an image.

In some embodiments, the apparatus further includes:
a second acquiring module, configured to acquire a template background image and a title style corresponding to a target activity identifier, the target activity identifier corresponding to at least one type identifier; and
a reward type binding module, configured to generate a reward identifier corresponding to the template background image and the title style, and establish a corresponding relation between the reward identifier and the at least one type identifier.

In some embodiments, the first acquiring module 41 is configured to:
acquire, in the case that the ending time corresponding to the target type identifier is reached, the template background image and the title style corresponding to the reward identifier, and acquire a title text corresponding to a target type identifier.

In some embodiments, the image saving module 43 includes:
an image saving unit, configured to send a target image to a content delivery network and acquire a download address of the target image from the content delivery network, the content delivery network being configured to save the target image and provide a downloading service of the target image; and
a download address saving unit, configured to accordingly save the reward identifier, the target type identifier, and the download address.

In some embodiments, the apparatus further includes:
a list entry account acquiring module, configured to acquire, in the case that the ending time corresponding to the target type identifier is reached, a list entry account identifier corresponding to the target type identifier, the list entry account identifier being an account identifier in a list corresponding to the target type identifier; and
an account reward binding module, configured to establish a corresponding relation between the list entry account identifier and the reward identifier.

In some embodiments, the apparatus further includes:
an acquisition request receiving module, configured to receive an acquisition request of a client for a target image, the acquisition request including a target account identifier;
a download address acquiring module, configured to determine, based on the corresponding relation between the list entry account identifier and the reward identifier, a reward identifier corresponding to the target account identifier, and acquire a download address corresponding to the reward identifier; and
a download address sending module, configured to send the download address to the client, the download address directing the client to download the target image according to the download address.

With respect to the apparatus in the above embodiments, the specific manner in which each module performs the operation has been described in detail in the embodiments related to the method, and will not be described in detail herein.

FIG. 5 is a block diagram of an electronic device according to some embodiments of the present disclosure. For example, the electronic device 500 is provided as a server. Referring to FIG. 5, the electronic device 500 includes a processing component 522, further including one or more processors, and memory resources represented by a memory 532 that are configured to store instructions (e.g., applications) executed by the processing component 522. In some embodiments, the applications stored in the memory 532 include one or more modules, each of the modules corresponding to a set of instructions. In addition, the processing component 522 is configured to execute the instructions to perform the method for processing the image described above.

In some embodiments, the electronic device 500 further includes a power component 526 configured to perform power management for the electronic device 500, a wired or wireless network interface 550 configured to connect the electronic device 500 to a network, and an input/output (I/O) interface 558. The electronic device 500 is capable of operating based on an operating system stored in the memory 532, such as Windows Server™, Mac OS X™, Unix™, Linux™, FreeBSD™, or the like.

In some embodiments, a non-transitory computer-readable storage medium including one or more instructions, such as a memory 532 including instructions, is further provided. The one or more instructions, when executed by the processing component 522 of the electronic device 500, cause the electronic device to perform the method for processing the image described above. In some embodiments, the computer-readable storage medium is a read-only memory (ROM), a random access memory (RAM), a compact disc read-only memory (CD-ROM), a magnetic tape, a floppy disk, an optical data storage device, and the like.

In some embodiments, a computer program product including one or more computer programs or one or more computer instructions is further provided. The one or more computer programs or the one or more computer instructions, when executed by a processor, cause the electronic device to perform the method for processing the image described above.

All embodiments of the present disclosure may be implemented alone or in combination with other embodiments and are considered to be within the protection scope of the present disclosure as claimed.

What is claimed is:

1. A method for processing an image in a competitive live-streaming event, executed by an electronic device, the method comprising:
acquiring a template background image and a title style corresponding to a reward identifier of the competitive live-streaming event, and acquiring a title text corresponding to a target type identifier, wherein the reward identifier corresponds to a plurality of type identifiers in the competitive live-streaming event, the target type identifier is configured to represent a corresponding target type, the title style is a presentation style of the title text, and the title text describes a rank corresponding to the target type identifier in the competitive live-streaming event;
acquiring a target image corresponding to the reward identifier and the target type identifier by synthesizing the title text into the template background image based on the title style, wherein the target image represents reward information corresponding to the target type identifier; and
accordingly saving the reward identifier, the target type identifier, and the target image.

2. The method for processing the image according to claim 1, wherein acquiring the target image corresponding to the reward identifier and the target type identifier by synthesizing the title text into the template background image based on the title style comprises:
generating, based on the title style and the template background image, a webpage template component;
acquiring a webpage picture by synthesizing the title text into the webpage template component; and
acquiring the target image by converting the webpage picture into an image.

3. The method for processing the image according to claim 1, further comprising:
acquiring a template background image and a title style corresponding to a target activity identifier, the target activity identifier corresponding to at least one type identifier; and
generating a reward identifier corresponding to the template background image and the title style, and establishing a corresponding relation between the reward identifier and the at least one type identifier.

4. The method for processing the image according to claim 1, wherein acquiring the template background image and the title style corresponding to the reward identifier, and acquiring the title text corresponding to the target type identifier comprises:
acquiring, in a case that an ending time corresponding to the target type identifier is reached, the template background image and the title style corresponding to the reward identifier, and acquiring the title text corresponding to the target type identifier.

5. The method for processing the image according to claim 1, wherein accordingly saving the reward identifier, the target type identifier, and the target image comprises:
sending the target image to a content delivery network, and acquiring a download address of the target image from the content delivery network, the content delivery network being configured to save the target image and provide a downloading service of the target image; and
accordingly saving the reward identifier, the target type identifier, and the download address.

6. The method for processing the image according to claim 5, further comprising:
acquiring, in a case that an ending time corresponding to the target type identifier is reached, a list entry account identifier corresponding to the target type identifier, the list entry account identifier being an account identifier in a reward list corresponding to the target type identifier; and
establishing a corresponding relation between the list entry account identifier and the reward identifier.

7. The method for processing the image according to claim 6, further comprising:
receiving an acquisition request of a client for the target image, the acquisition request comprising a target account identifier;
determining, based on the corresponding relation between the list entry account identifier and the reward identifier, a reward identifier corresponding to the target account identifier, and acquiring a download address corresponding to the reward identifier; and
sending the download address to the client, the download address directing the client to download the target image based on the download address.

8. An electronic device for processing an image in a competitive live-streaming event, comprising:
a processor; and
a memory configured to store one or more instructions executed by the processor;
wherein the processor, when loading and executing the one or more instructions, is caused to perform:
acquiring a template background image and a title style corresponding to a reward identifier of the competitive live-streaming event, and acquiring a title text corresponding to a target type identifier, wherein the reward identifier corresponds to a plurality of type identifiers in the competitive live-streaming event, the target type identifier is configured to represent a corresponding target type, the title style is a presentation style of the title text, and the title text describes a rank corresponding to the target type identifier in the competitive live-streaming event;
acquiring a target image corresponding to the reward identifier and the target type identifier by synthesizing the title text into the template background image based on the title style, wherein the target image represents reward information corresponding to the target type identifier; and
accordingly saving the reward identifier, the target type identifier, and the target image.

9. The electronic device according to claim 8, wherein the processor, when loading and executing the one or more instructions, is caused to perform:
generating, based on the title style and the template background image, a webpage template component;
acquiring a webpage picture by synthesizing the title text into the webpage template component; and
acquiring the target image by converting the webpage picture into an image.

10. The electronic device according to claim 8, wherein the processor, when loading and executing the one or more instructions, is caused to perform:
acquiring a template background image and a title style corresponding to a target activity identifier, the target activity identifier corresponding to at least one type identifier; and
generating a reward identifier corresponding to the template background image and the title style, and establishing a corresponding relation between the reward identifier and the at least one type identifier.

11. The electronic device according to claim 8, wherein the processor, when loading and executing the one or more instructions, is caused to perform:
acquiring, in a case that an ending time corresponding to the target type identifier is reached, the template background image and the title style corresponding to the reward identifier, and acquiring the title text corresponding to the target type identifier.

12. The electronic device according to claim 8, wherein the processor, when loading and executing the one or more instructions, is caused to perform:
sending the target image to a content delivery network, and acquiring a download address of the target image from the content delivery network, the content delivery network being configured to save the target image and provide a downloading service of the target image; and
accordingly saving the reward identifier, the target type identifier, and the download address.

13. The electronic device according to claim 12, wherein the processor, when loading and executing the one or more instructions, is caused to perform:
acquiring, in a case that an ending time corresponding to the target type identifier is reached, a list entry account identifier corresponding to the target type identifier, the list entry account identifier being an account identifier in a list corresponding to the target type identifier; and
establishing a corresponding relation between the list entry account identifier and the reward identifier.

14. The electronic device according to claim 13, wherein the processor, when loading and executing the one or more instructions, is caused to perform:
receiving an acquisition request of a client for the target image, the acquisition request comprising a target account identifier;
determining, based on the corresponding relation between the list entry account identifier and the reward identifier, a reward identifier corresponding to the target account identifier, and acquiring a download address corresponding to the reward identifier; and
sending the download address to the client, the download address directing the client to download the target image based on the download address.

15. A non-transitory computer-readable storage medium storing one or more instructions therein, wherein the one or more instructions, when loaded and executed by a processor of an electronic device for processing an image in a competitive live-streaming event, cause the electronic device to perform:
acquiring a template background image and a title style corresponding to a reward identifier of the competitive live-streaming event, and acquiring a title text corresponding to a target type identifier, wherein the reward identifier corresponds to a plurality of type identifiers in the competitive live-streaming event, the target type identifier is configured to represent a corresponding target type, the title style is a presentation style of the title text, and the title text describes a rank corresponding to the target type identifier in the competitive live-streaming event;
acquiring a target image corresponding to the reward identifier and the target type identifier by synthesizing the title text into the template background image based on the title style, wherein the target image represents reward information corresponding to the target type identifier; and
accordingly saving the reward identifier, the target type identifier, and the target image.

16. The non-transitory computer-readable storage medium according to claim 15, wherein the one or more instructions, when loaded and executed by a processor of an electronic device, cause the electronic device to perform:
generating, based on the title style and the template background image, a webpage template component;
acquiring a webpage picture by synthesizing the title text into the webpage template component; and
acquiring the target image by converting the webpage picture into an image.

17. The non-transitory computer-readable storage medium according to claim 15, wherein the one or more instructions, when loaded and executed by a processor of an electronic device, cause the electronic device to perform:
acquiring a template background image and a title style corresponding to a target activity identifier, the target activity identifier corresponding to at least one type identifier; and
generating a reward identifier corresponding to the template background image and the title style, and establishing a corresponding relation between the reward identifier and the at least one type identifier.

18. The non-transitory computer-readable storage medium according to claim 15, wherein the one or more instructions, when loaded and executed by a processor of an electronic device, cause the electronic device to perform:
acquiring, in a case that an ending time corresponding to the target type identifier is reached, the template background image and the title style corresponding to the reward identifier, and acquiring the title text corresponding to the target type identifier.

19. The non-transitory computer-readable storage medium according to claim 15, wherein the one or more instructions, when loaded and executed by a processor of an electronic device, cause the electronic device to perform:
sending the target image to a content delivery network, and acquiring a download address of the target image from the content delivery network, the content delivery network being configured to save the target image and provide a downloading service of the target image; and
accordingly saving the reward identifier, the target type identifier, and the download address.

20. The non-transitory computer-readable storage medium according to claim 19, wherein the one or more instructions, when loaded and executed by a processor of an electronic device, cause the electronic device to perform:
acquiring, in a case that an ending time corresponding to the target type identifier is reached, a list entry account identifier corresponding to the target type identifier, the list entry account identifier being an account identifier in a list corresponding to the target type identifier; and
establishing a corresponding relation between the list entry account identifier and the reward identifier.
